(19) United States
(12) Patent Application Publication
(10) Pub. No.: US 2018/0001561 A1
(43) Pub. Date: Jan. 4, 2018

(54) THREE-DIMENSIONAL PRINTING OF INVESTMENT CASTING PATTERNS

(71) Applicants: Michael G. Hascher, Medina, OH (US); William Buckley, Mount Vernon, OH (US)

(72) Inventors: Michael G. Hascher, Medina, OH (US); William Buckley, Mount Vernon, OH (US)

(21) Appl. No.: 15/523,773

(22) PCT Filed: Aug. 22, 2016
(86) PCT No.: PCT/US2016/048036

§ 371 Date: May 2, 2017

Related U.S. Application Data
(60) Provisional application No. 62/207,450, filed on Aug. 20, 2015.

(51) Int. Cl. B29C 64/386; B33Y 80/00; B22C 7/02; B33Y 50/00; B29C 64/106; B33Y 30/00; B33Y 10/00

(52) U.S. Cl. CPC B29C 64/386; B22C 7/02; B33Y 80/00; B33Y 50/00; B33Y 30/00; B33Y 10/00; B29C 64/106

(57) ABSTRACT

A system and method for generating investment casting patterns by 3D printing. CAD software is used to generate a hollow 3D model of a solid 3D model of a desired pattern. The pattern is generated by a 3D printer which prints the exterior of the pattern in pattern wax and the interior in support wax.

### RELATED APPLICATIONS

This application claims the benefit of U.S. Provisional Application No. 62/207,450 filed Aug. 20, 2015, which is hereby incorporated herein by reference.

### TECHNICAL FIELD

The present invention relates generally to three-dimensional (3D) printing of investment casting patterns for use in investment casting applications.

### BACKGROUND

Modern investment casting methods typically involve manufacturing an investment casting pattern by injecting liquid or paste wax into an aluminum or steel mold and ejecting a solidified (solid) investment casting pattern from the mold. The design and building of molds and tools is an expensive and time consuming process.

Use of 3D printing of investment casting patterns as an alternative to injection molding has been limited to primarily rapid prototyping and/or low-scale or low-precision applications. Widespread use of 3D printed investment casting patterns has been restricted by a large cost differential between the materials used in 3D printing in comparison to those used in injection molding, strength disadvantages of investment casting patterns created with pattern wax, and a comparative lack of precision across the exterior surface area of investment casting patterns created with pattern wax.

### BRIEF SUMMARY OF EXAMPLE EMBODIMENTS

Aspects of the present invention relate to the use of 3D printing equipment, software, and materials for creation of investment casting patterns.

3D printers may utilize two materials, for example, pattern wax and support wax. A desired object to be printed is generated in pattern wax by the 3D printer. As 3D printing is conducted layer-by-layer, down-facing surfaces of the desired object are printed up to by using support wax. The support wax on the down-facing surfaces of the printed object are removed upon completion, leaving the finished pattern wax object.

Pattern wax and support wax have different material properties, including, but not limited to, thermodynamic and mechanical properties. Pattern wax is also currently significantly more expensive than support wax. For example, pattern wax may be three times the cost of support wax.

As stated above, widespread use of 3D printed investment casting patterns has been restricted by a large cost differential between the materials used in 3D printing in comparison to those used in injection molding, pattern strength disadvantages of investment casting patterns created with pattern wax, and a comparative lack of precision across the exterior surface area of investment casting patterns created with pattern wax.

Aspects of the present invention overcome these problems and create a 3D printed investment casting pattern system and method that reduces the use of highest priced pattern wax material by as much as 90%, increases the strength of the 3D printed investment casting pattern, and produces a high precision exterior finish of the investment casting pattern. The investment casting pattern created by the system and method is also lighter in weight and reduces the energy necessary to remove the pattern from the mold during the investment casting process.

In an embodiment, a method for acquiring at least one solid 3-dimensional (3D) model of a desired investment casting pattern by an associated computer aided drafting (CAD) device is provided. The solid 3D model can be acquired by CAD software on the associated CAD device. The solid 3D model is processed with the CAD software to generate a 3D hollow model of the desired investment casting pattern. The 3D hollow pattern includes an exterior surface of a particular thickness surrounding a substantially hollow interior. The 3D hollow model is transferred to an associated 3D printing device, and, the 3D printing device, upon receipt of the 3D hollow model, generates the desired investment casting pattern by printing the exterior of the investment casting pattern in a first material and printing the substantially hollow interior of the investment casting pattern with a second material.

In an embodiment, the particular thickness of the exterior surface of the 3D hollow model varies at different points on the exterior surface of the 3D hollow model.

In an embodiment, the particular thickness of the exterior of the 3D hollow model is determined by geometric constraints.

In an embodiment, the particular thickness of the exterior of the 3D hollow model varies between 0.001 inches to 1.250 inches.

In an embodiment, the particular thickness of the exterior of the 3D hollow model varies between 0.008 inches to 0.030 inches.

In an embodiment, the second material has a fractal build structure.

In an embodiment, the second material has a solid build structure.

In an embodiment, the first material is pattern wax .

In an embodiment, the second material is support wax.

In an embodiment, a system for creating an investment casting pattern is provided. The system includes a first material, a second material, a computer aided design (CAD) device including CAD software, and, at least one 3-dimensional (3D) printing device operatively coupled to the CAD device. The 3D printing device is configured to receive the first material and the second material. The CAD software is configured to acquire at least one solid 3D model of a desired investment casting pattern and process the solid 3D model to generate a 3D hollow model of the desired investment casting pattern having an exterior surface of a particular thickness surrounding a substantially hollow interior. Upon receipt of the 3D hollow model, the 3D printing device generates the desired investment casting pattern by printing the exterior of the investment casting pattern in the first material and the substantially hollow interior of the investment casting pattern in the second material.

In an embodiment, the particular thickness of the exterior surface of the 3D hollow model varies at different points on the exterior surface of the 3D hollow model.

In an embodiment, the particular thickness of the exterior of the 3D hollow model is determined by geometric constraints.

In an embodiment, the particular thickness of the exterior surface of the 3D hollow model varies between 0.001 inches to 1.250 inches.

In an embodiment, the particular thickness of the exterior of the 3D hollow model varies between 0.008 inches to 0.030 inches.

In an embodiment, the second material has a fractal build structure.

In an embodiment, the second material has a solid build structure.

In an embodiment, the first material is pattern wax.

In an embodiment, the second material is support wax.

In an embodiment, an investment casting pattern including an exterior surface of a particular thickness of pattern wax surrounding an interior substantially filled with support wax is provided. The investment casting pattern can be created by any combination of the presented method embodiments.

The foregoing and other features of the application are described below with reference to the drawings.

### BRIEF DESCRIPTION OF THE DRAWINGS

FIG. 1 is a block diagram illustrating an exemplary system in accordance with aspects of the present invention.

FIGS. 2A, 2B, 2C, 2D, and 2E illustrate exemplary views of 3D models of investment casting patterns in accordance with embodiments of the present invention.

FIGS. 3A, 3B, and 3C illustrate exemplary views of a completed physical 3D printed investment casting pattern produced according to an embodiment of the present invention.

FIG. 4 is a block diagram illustrating an exemplary method in accordance with aspects of the present invention.

### DETAILED DESCRIPTION

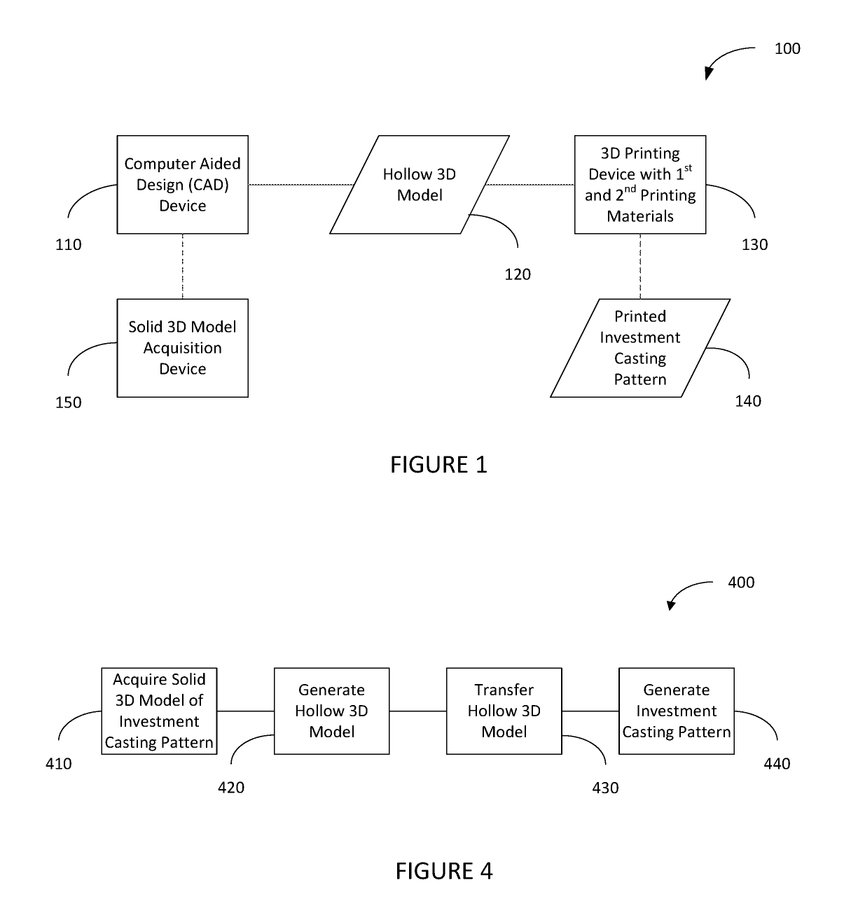

An exemplary system 100 for the production of 3D printed investment casting patterns in accordance with aspects of the present invention is illustrated in FIG. 1. The system 100 includes a computer aided design (CAD) device or other suitable device 110, a 3D printing device 130, and, in some embodiments, may include a solid 3D model acquisition device 150 (e.g., camera, scanner, laser, etc.).

The CAD device 110 may be any suitable electronic device and may include CAD software or other suitable design software, a graphical display, and input/output interface (e.g., keyboard, mouse, stylus, and the like) for receiving, modifying, and generating electronic files (e.g., 3D CAD files) representing a 3D object.

The CAD device 110 may include a general purpose computer or set of computers. Alternatively, a proprietary processing system specifically configured for CAD may be used. The CAD software may be any computer program which enables detailed engineering of 3D models. The CAD software may be local and stored on the electronic device. The electronic device may also allow use of remote software such as software-as-a-service in a cloud computing environment or the like.

The CAD device 110 may be used by a designer, engineer, or other user (hereafter, “designer”) to generate a hollow 3D printer pattern to be constructed by the 3D printing device 130. The 3D printing device 130 may be a single 3D printer or may be a plurality (e.g., a network) of 3D printers. The 3D printers may be located geographically near each other (e.g., next to each other or in the same building) or they may be geographically dispersed (e.g., in different buildings). The 3D printers may contain at least a first printing material and a second printing material.

In an exemplary embodiment, the designer may begin by acquisition of a solid 3D model of a desired investment casting pattern. The desired investment casting pattern may be an individual investment casting pattern or may be a combination of investment casting patterns of an entire mold assembly.

In some embodiments, a single solid 3D model may be divided into a plurality of solid 3D models. Each of the plurality of solid 3D models may be processed individually on the CAD device 110 so that hollow 3D models 120 may be created for each of the plurality of solid 3D models. Each of the plurality of hollow 3D models may then be sent to the 3D printing device 130.

The solid 3D model of an investment casting pattern may be acquired directly on CAD device 110. For example, the investment casting pattern may be designed from scratch by the designer in the CAD software or a previously designed pattern may be loaded into the CAD software of the CAD device 110. In some embodiments, the solid 3D model acquisition device 150 may be used to acquire a solid 3D model of the investment casting pattern. The solid 3D model acquisition device, for example, may be a camera, a laser, and/or a white light and/or blue light scanner interfaced with the CAD software, which generates a solid 3D model of the physical object captured by the acquisition device. Other acquisition techniques may include, but are not limited to, physical transducers, ultrasonic transducers, and the like. Although one solid 3D model acquisition device 150 is shown in FIG. 1, a plurality of solid 3D model acquisition devices may be used in some embodiments. The plurality of 3D model acquisition devices may utilize common or different acquisition techniques.

Upon acquisition of the solid 3D model of the investment casting pattern into the CAD software of the CAD device 110, processing of the model is conducted to generate a hollow 3D model 120 of the solid 3D model. Processing may be done directly by the designer using the graphical display and input/output devices of the CAD device 110, or may be done via algorithms that have been automated that may be employed by the CAD software.

The thickness of the exterior surface of the hollow 3D model 120 may depend upon determined constraints, including, but not limited to, geometric constraints, constraints of the materials involved, the costs of the material types, structural requirements necessary for the final investment casting pattern, or constraints of the specific 3D printing device 130. The thickness of the exterior surface of the hollow 3D model 120 may be uniform or may vary along any cross-section or at any point within the hollow 3D model 120, depending upon the determined constraints.

In some embodiments, the thickness may range from 0.001 inches to 1.250 inches. In a further embodiment, the thickness may range from 0.008 inches to 0.030 inches. In an embodiment, a hole of a particular shape and size may be included at a particular point of the exterior surface in the hollow 3D model 120.

In an example embodiment, the solid 3D model may be assessed region by region to determine actual thicknesses of the solid 3D model across its geometry. For example, a solid 3D model may have a first region having a total solid thickness of 0.004 inches abutting a second region having a total solid thickness of 1.000 inches. Based on the determined actual thickness of each region of the solid 3D model, regions that exceed a particular thickness may be assigned specific criteria during processing to generate the hollow 3D model 120.

Assignment of the specific criteria for each designated region is based on any of the constraints of the individual regions and/or the overall intended final printed investment casting pattern 140. The specific criteria may include the individual exterior surface thickness at any designated point and/or an exterior surface thickness gradient across any designated region of the hollow 3D pattern 120.

In one embodiment, a first region of processed hollow 3D model 120 may be designated as solid at a particular thickness, for example, 0.004 inches while a second region may be designated as hollow with a uniform exterior surface thickness of that same particular value, for example, 0.004 inches. In a second embodiment, the first region may be designated as solid with a particular exterior surface thickness, for example, 0.004 inches, while the second region may be designated as hollow with an exterior surface thickness varying as a gradient beginning at a first particular value, for example, 0.004 inches, to a second particular thickness, for example, 0.008 inches. Any number and combinations of particular values may be used within or across regions.

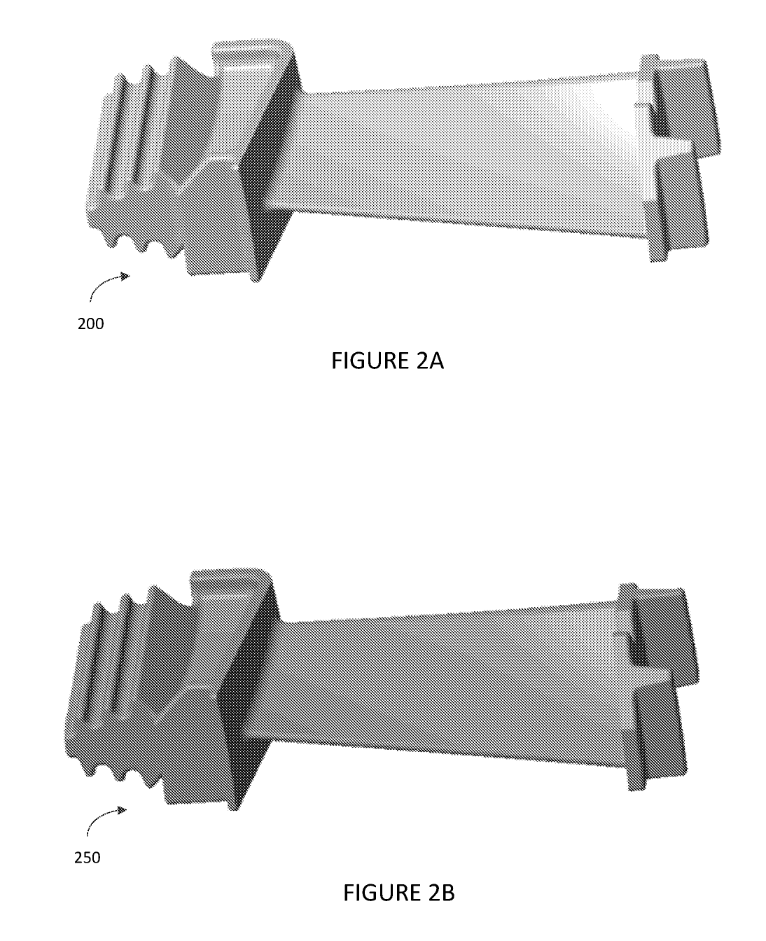

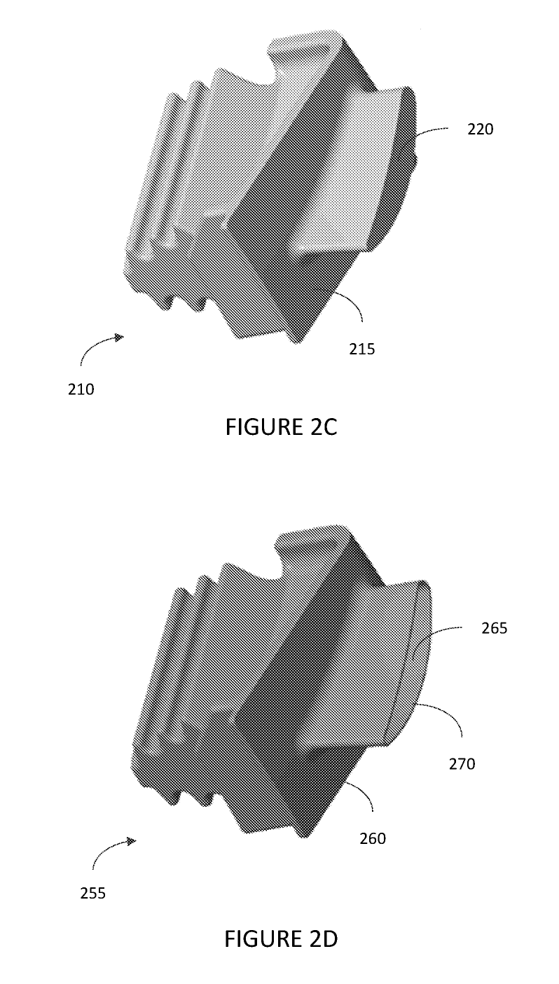

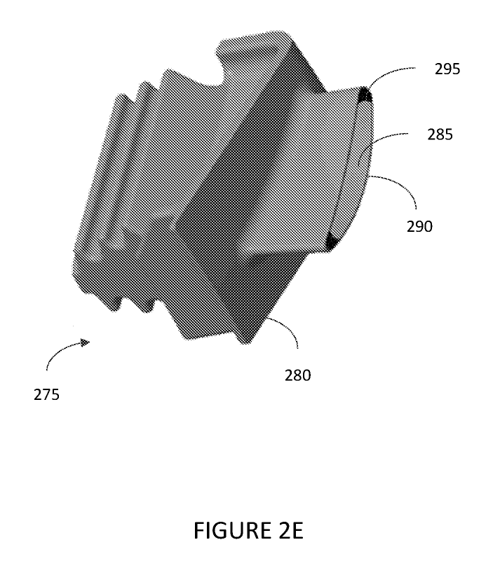

FIGS. 2A, 2B, 2C, 2D, and 2E illustrate example computer software 3D models that may be utilized in, for example, the system 100 described above and/or in the method 400, which will be described in detail in a later embodiment.

FIG. 2A shows a solid 3D model 200 as may be acquired by the CAD software, for example, in the system 100. FIG. 2B shows a hollow 3D model 250 of the solid 3D model 200 as may result after processing, for example, in the system 100. From the viewing angle of FIGS. 2A and 2B, which show the exterior of both models, the two 3D models 200 and 250 appear structurally identical.

FIG. 2C shows a partial cross-section 210 of the solid 3D model 200. Likewise, FIG. 2D shows a partial cross-section 255 of the hollow 3D model 250. The cross-section 210 of the solid 3D model 200 has an exterior surface 215 and a solid interior 220 intended to be formed of the same material. The cross-section 255 of hollow 3D model 250 has an exterior surface 260 and a substantially hollow interior 265. The exterior surface 260 has a particular thickness at any designated point 270 on the hollow 3D model 200, 255. In the embodiment illustrated in the partial cross-section 255 of FIG. 2D, the particular thickness of the exterior surface may be substantially uniform at the particular cross-section.

In a further embodiment, FIG. 2E illustrates a partial cross-section 275 that also corresponds to a portion of the hollow 3D model 250 in FIG. 2B. Partial cross-section 275 also has an exterior 280 and a substantially hollow interior 285. As presented above, the particular thickness of a point along the exterior surface may vary according to a number of determined constraints associated with the desired investment casting pattern. In this embodiment, the thickness of the exterior surface 280 varies between a thinner exterior surface in a first region 290 and a thicker exterior surface in a second region 295. The thickness may vary anywhere on the model.

The CAD device 110 may transmit the hollow 3D model 120, for example, hollow 3D model 250, to the 3D printing device 130 to print the investment casting pattern 140. The 3D printing device 130 may utilize a secondary material, for example, support wax (hereafter, second material or support wax), to print up to any down-facing surfaces to be printed with the primary material, for example, pattern wax (hereafter, first material or pattern wax). The 3D printing device may also fill in at least some of the hollow portions, and up to all or substantially all of the hollow portions of the printed object, including the interior 265,285 of the hollow 3D model 250. The printed investment casting pattern 140 will, therefore, be an investment casting pattern with a pattern wax exterior of a particular thickness filled, at least partially or completely with support wax, based on the hollow 3D model 250 and/or the constraints of the 3D printing device 130.

The printing of support wax may vary in build structure. Support wax may be printed with a fractal (e.g., expanding symmetry or evolving symmetry) structure, a solid structure, or a combination of fractal and solid build structures. In an embodiment, a honeycomb build structure may be used.

Exterior support wax attached to down-facing portions of the exterior surface of the printed investment casting pattern 140 may still be removed after printing is complete. The investment casting pattern may then be used in an investment casting process.

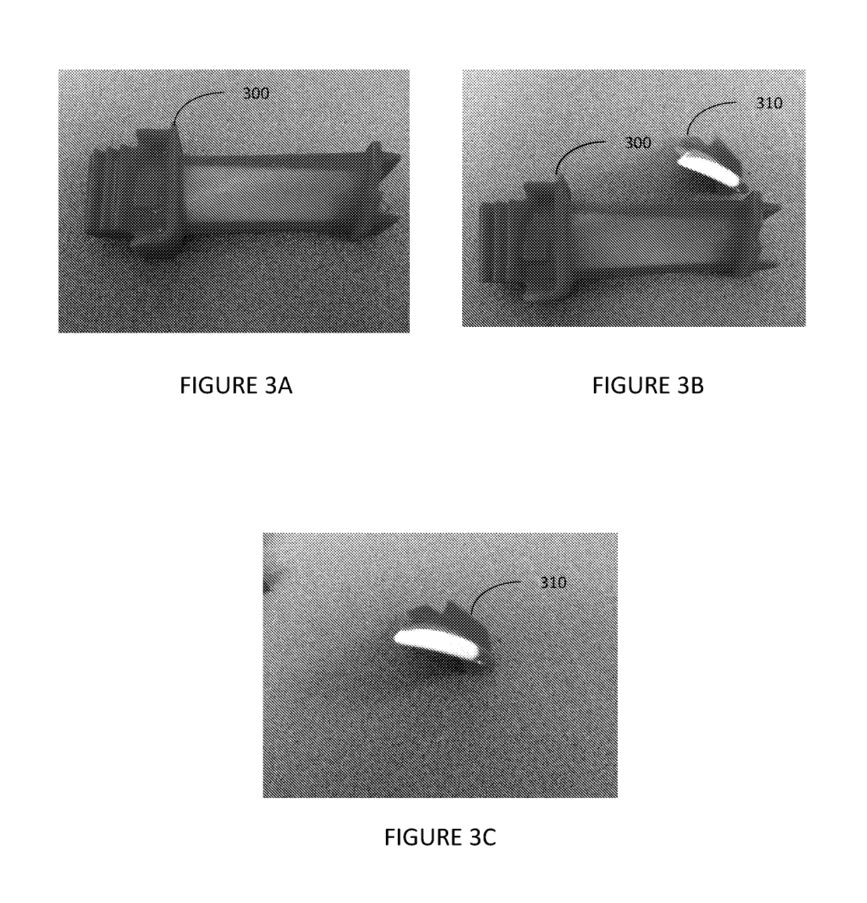

FIGS. 3A, 3B, and 3C show example views of a physical 3D printed investment casting pattern generated by an example embodiment, for example, using hollow 3D pattern 120 in system 100.

FIG. 3A shows an exterior view of the finished investment casting pattern 300 formed from model 250. The exterior is constructed from pattern wax. FIG. 3B shows a cross-section portion 310 of investment casting pattern 300. As can be seen from the cross-section portion 310 of FIG. 3B, the investment casting pattern 300 includes a pattern wax exterior filled with support wax. FIG. 3C illustrates an isolated and slightly enlarged view of the cross-section portion 310 showing the pattern wax exterior filled with support wax.

Turning now to FIG. 4, an exemplary method 400 for creating an investment casting pattern is illustrated. The method 400 begins by the acquisition of a solid 3D model of a desired investment casting pattern at 410, for example, the solid 3D model 200 may be acquired by CAD device 110 and/or solid 3D model acquisition device 150. Further details of example embodiments of acquisition of the solid 3D model were previously disclosed in reference to the system 100.

At 420, a hollow 3D model of the investment casting pattern is generated, for example, the hollow 3D model 120 in system 100. For example, processing of the solid 3D model 200 is conducted, for example, by CAD device 110, to generate the hollow 3D model 250 of the previously solid 3D model 200. Further details of example embodiments of generation and properties of the hollow 3D models were previously disclosed in reference to the system 100.

The hollow 3D model is transferred to the 3D printing device as shown at 430. For example, the hollow 3D model 120 may be sent to the 3D printing device 130, as previously disclosed in more detail above.

The 3D printing device generates (i.e., 3D prints) the investment casting pattern as shown at 440. The 3D printing device, for example, the 3D printing device 130, uses the transferred hollow 3D model, for example, the hollow 3D model 120, to generate the investment casting pattern (e.g., printed investment casting pattern 140). For example, the 3D printing device 130 may utilize support wax to print up to any down-facing surfaces to be printed with pattern wax. The 3D printing device may also fill in at least some of the hollow portions, and up to substantially all of the hollow portions of the printed object, including the interior of the hollow 3D model 120. The printed investment casting pattern 140 will, therefore, be an investment casting pattern with a pattern wax exterior of a particular thickness filled, at least partially or up to substantially, with support wax, based on the hollow 3D model 120 and/or the constraints of the 3D printing device 130.

As presented above, advantages of the disclosed system and method include reduction of the use of highest priced pattern wax material by as much as 90%, increasing the strength of the 3D printed investment casting pattern, and producing a high precision exterior finish of the investment casting pattern. The investment casting pattern created by the system and method is also lighter in weight thus reducing the energy necessary to remove the pattern from the mold during the investment casting process.

For example, because support wax melts at a lower temperature than pattern wax, utilization of support wax in the interior of the investment casting pattern can function as a heat sink to counteract the printing of solid pattern wax that can cause pits and other surface imperfections that make a 3D printed pattern wax investment casting pattern problematic in casting high-precision objects. Also, as mentioned earlier, the lower melting temperature of the support wax also reduces the energy necessary to remove the investment casting pattern from the mold during the investment casting de-waxing process.

In addition, support wax, having a higher strength than pattern wax, in the interior of the investment casting pattern also increases the overall structural strength of the 3D printed investment casting pattern. This structural increase in overall strength is observed in both fractal and solid build structures.

In contrast to other additive manufacturing methods of creating investment casting patterns, the disclosed system and method also overcomes limitations exposed in conventional additive manufacturing methods. For example, it is known in the art of investment casting that use of hollow patterns are problematic and result in unstable, sometimes minor explosive, results during the autoclaving process.

Also, in stereolithography, which uses photosensitive epoxy patterns, investment casting patterns created with fractal internal builds cause distortion problems during the investment casting dewaxing process. However, it was observed that, in contrast to the distortion problems observed in stereolithography fractal-build investment casting patterns, 3D printed investment casting patterns utilizing the disclosed system and method not only lacked such distortion but resulted in higher-precision exterior surfaces than 3D printed investment casting patterns created by conventional methods, even in embodiments using fractal internal builds.

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although certain embodiments have been shown and described, it is understood that equivalents and modifications falling within the scope of the appended claims will occur to others who are skilled in the art upon the reading and understanding of this specification.

1. A method for creating an investment casting pattern comprising:
acquiring at least one solid 3-dimensional (3D) model of a desired investment casting pattern by an associated computer aided drafting (CAD) device, wherein the solid 3D model is acquired by CAD software on the associated CAD device;
processing the solid 3D model with the CAD software to generate a 3D hollow model of the desired investment casting pattern, the 3D hollow pattern comprising an exterior surface of a particular thickness surrounding a substantially hollow interior;
transferring the 3D hollow model to an associated 3D printing device; and
generating, by the associated 3D printing device upon receipt of the 3D hollow model, the desired investment casting pattern by printing the exterior of the investment casting pattern in a first material and printing the substantially hollow interior of the investment casting pattern with a second material.

2. The method of claim 1, wherein the particular thickness of the exterior surface of the 3D hollow model varies at different points on the exterior surface of the 3D hollow model.

3. The method of claim 1, wherein the particular thickness of the exterior of the 3D hollow model is determined by geometric constraints.

4. The method of claim 1, wherein the particular thickness of the exterior of the 3D hollow model varies between 0.001 inches to 1.250 inches.

5. The method of claim 4, wherein the particular thickness of the exterior of the 3D hollow model varies between 0.008 inches to 0.030 inches.

6. The method of claim 1, wherein the second material has a fractal build structure.

7. The method of claim 1, wherein the second material has a solid build structure.

8. The method of claim 1, wherein the first material is pattern wax.

9. The method of claim 1, wherein the second material is support wax.

10. A system for creating an investment casting pattern comprising:
a first material;
a second material;
a computer aided design (CAD) device including CAD software; and
at least one 3-dimensional (3D) printing device operatively coupled to the CAD device, the 3D printing device being configured to receive the first material and the second material,
wherein the CAD software is configured to acquire at least one solid 3D model of a desired investment casting pattern and process the solid 3D model to generate a 3D hollow model of the desired investment casting pattern having an exterior surface of a particular thickness surrounding a substantially hollow interior, and
wherein upon receipt of the 3D hollow model, the 3D printing device is configured to generate the desired investment casting pattern by printing the exterior of the investment casting pattern in the first material and the substantially hollow interior of the investment casting pattern in the second material.

11. The system of claim 10, wherein the particular thickness of the exterior surface of the 3D hollow model varies at different points on the exterior surface of the 3D hollow model.

12. The system of claim 10, wherein the particular thickness of the exterior of the 3D hollow model is determined by geometric constraints.

13. The system of claim 10, wherein the particular thickness of the exterior surface of the 3D hollow model varies between 0.001 inches to 1.250 inches.

14. The system of claim 13, wherein the particular thickness of the exterior of the 3D hollow model varies between 0.008 inches to 0.030 inches.

15. The system of claim 10, wherein the second material has a fractal build structure.

16. The system of claim 10, wherein the second material has a solid build structure.

17. The system of claim 10, wherein the first material is pattern wax.

18. The system of claim 10, wherein the second material is support wax.

19. An investment casting pattern comprising an exterior surface of a particular thickness of pattern wax surrounding an interior substantially filled with support wax, the investment casting pattern being created by the method according to claim 1.
